(19) United States
(12) Patent Application Publication
(10) Pub. No.: US 2011/0181692 A1
(43) Pub. Date: Jul. 28, 2011

(54) REPRODUCING APPARATUS

(75) Inventor: YOSHIKI KUNO, Osaka (JP)

(73) Assignee: PANASONIC CORPORATION, Osaka (JP)

(21) Appl. No.: 13/012,481

(22) Filed: Jan. 24, 2011

(30) Foreign Application Priority Data
Jan. 25, 2010 (JP) 2010-012711

(51) Int. Cl. H04N 13/00

(52) U.S. Cl. 348/43; 348/E13.001

(57) ABSTRACT

A reproducing apparatus includes an OSD creating unit operable to create an OSD display image, an OSD combining unit operable to combine an image and the OSD display image created in the OSD creating unit, and an outputting unit operable to output a signal of the image with which the OSD display image is combined by the OSD combining unit, to a display apparatus which can display an image stereoscopically outside the reproducing apparatus, and, when a 3D image output format of the reproducing apparatus is set to a top and bottom format, the OSD combining unit arranges the OSD display image at a position, of an image inputted in the OSD combining unit, which does not cross a center line dividing the image into left and right images.

### BACKGROUND

1. Technical Field

The technical field relates to a reproducing apparatus such as a stereoscopic (3D) television which enables stereovision using two image signals having parallax between left and right images.

2. Related Art

Recently, a 3D television technique which can display stereoscopic images is rapidly being developed. For example, 3D movies are shown in movie theaters, and 3D programs are broadcasted on a trial basis at some broadcast stations in BS digital broadcasting. 3D televisions have already been commercialized from some manufacturers, and a 3D viewing environment is being organized in general households. There are roughly two methods as 3D television viewing methods. These include a method of viewing stereoscopic images with naked eyes and a method of viewing stereoscopic images by wearing dedicated glasses.

The method of viewing stereoscopic images with naked eyes includes a parallax barrier system or lenticular system as disclosed in, for example, JP-A-9-43540 or JP-A-9-318911. It is known that the method of viewing stereoscopic images with naked eyes has a problem that, with the parallax barrier system, a position to view stereoscopic images is limited and a barrier is obtrusive. By contrast with this, it is known that, with the lenticular system, resolution substantially decreases and the lenses are obtrusive.

The method of viewing stereoscopic images by wearing dedicated glasses includes a method of viewing stereoscopic images using polarized glasses with a special film attached on a television as disclosed in, for example, JP-B-3796414, and a method of viewing stereoscopic images using liquid crystal shutter glasses as disclosed in JP-A-6-254046 and JP-A-7-336729.

There are roughly two 3D image formats. The first format is a format of reducing, thinning and combining a left eye image and a right eye image in one image. The other format is a format of arranging one left eye image and one right eye image alternately temporally.

Typical formats of reducing, thinning and combining a left eye image and right eye image in one image include a top and bottom format and a side by side format. The top and bottom format is a format which generates an image of 1920×540 which is half the number of pixels by thinning pixels of the left eye image and right eye image each originally having the number of pixels of 1920×1080 in each vertical direction (up and down directions), and combines the left eye image and right eye image which are generated in this way and have half the number of the pixels to generate one image of 1920×1080. The side by side format is a format which generates an image of 960×1080 which is half the number of the pixels by thinning the pixels of the left eye image and right eye image having the number of pixels of 1920×1080 in each horizontal direction, and combines the left eye image and right eye image which are generated in this way and have half the number of pixels to generate one image of 1920×1080. In addition to these, there is a checker format. With the checker format, pixels of 1920×1080 of the left eye image and right eye image are thinned every other pixel in each of the horizontal direction and vertical direction, and the pixels of the left eye image and pixels of the right eye image are arranged alternately one by one. That is, the checker format is a format which arranges the pixels forming the left eye image and right eye image like a checkered pattern of a grid and combines the left eye image and right eye image to generate one image of 1920×1080. In addition, there is a line by line format. The line by line format is a format which alternately arranges lines forming a left eye image and lines forming a right eye image while thinning the lines of the left eye image and right eye image each having 1080 lines, every other line, and then combines the left eye image and right eye image to generate one image of 1080 lines.

Thus, there are various formats of 3D image formats. Accordingly, a reproducing apparatus which reproduces a 3D image needs to output a 3D image according to a 3D image input format of a display apparatus. The technique of converting the format of a 3D image and outputting the 3D image according to the 3D image input format of a display apparatus is disclosed in, for example, JP-A-2006-33851.

When the user can set 3D image formats of a reproducing apparatus and a display apparatus, if the 3D image formats of the reproducing apparatus and display apparatus are set to different formats, there is a problem that 3D images are not adequately displayed on the display apparatus.

Therefore, it can be considered to overlay a display for operating the devices (hereinafter, referred to as “OSD display”) for reporting the format of playing back images in the reproducing apparatus, on a image, and display it. However, in this case, there is the following problem.

For example, it is assumed that the 3D display format of the display apparatus is set to the top and bottom format, and the output format of the reproducing apparatus is set to the side by side format. FIG. 10 is a view illustrating these cases. More specifically, FIG. 10(a) is a view illustrating a 3D image to be displayed. FIG. 10(b) is a view illustrating a test pattern image of the side by side format. FIG. 10(c) is a view illustrating an image overlaying the test pattern image of the side by side format and an OSD display image. FIG. 10(d) is a view illustrating a left eye image which is displayed on a display apparatus when the display apparatus is set to the top and bottom format. FIG. 10(e) is a view illustrating a right eye image which is displayed on the display apparatus when the display apparatus is set to the top and bottom format. FIG. 10(f) is a view illustrating an image which is viewed by the user when the display apparatus is set to the top and bottom format (image combining the image illustrated in FIG. 10(d) and the image illustrated in FIG. 10(e), hereinafter referred to as “test image”). When the output format of the reproducing apparatus is erroneously set to the side by side format, the display image illustrated in FIG. 10(c) is divided into the upper half and lower half as illustrated in FIGS. 10(d) and 10(e) and the divided images are each enlarged twice in the up and down directions. Then, these enlarged images are overlaid, so that the image illustrated in FIG. 10(f) is viewed by the user. With this image, texts forming the OSD display are separated upward and downward, thereby making it difficult to read a message of the OSD display.

Further, it is assumed that the 3D display format of the display apparatus is set to the side by side format and the output format of the reproducing apparatus is set to the top and bottom format. FIG. 11 is a view illustrating this case. More specifically, FIG. 11(a) is a view illustrating a 3D image to be displayed. FIG. 11(b) is a view illustrating a test pattern image of the top and bottom format. FIG. 11(c) is a view illustrating an image overlaying a test pattern image of the top and bottom format and an OSD display image. FIG. 11(d) is a view illustrating a left eye image which is displayed on the display apparatus when the display apparatus is set to the side by side format. FIG. 11(e) is a view illustrating a right eye image which is displayed on the display apparatus when the display apparatus is set to the side by side format. FIG. 11(f) is a view illustrating a test image (image combining the image illustrated in FIG. 11(d) and the image illustrated in FIG. 11(e)) which is viewed by the user when the display apparatus is set to the side by side format. When the output format of the reproducing apparatus is erroneously set to the top and bottom format, the display image illustrated in FIG. 11(c) is divided into the left half and right half as illustrated in FIGS. 11(d) and 11(e) and the divided images are each enlarged twice in the horizontal direction. Then, these enlarged images are overlaid, so that the image illustrated in FIG. 11(f) is viewed by the user. With this image, texts forming the OSD display overlay, thereby making it difficult to read a message of the OSD display.

As described above, when the user can set the 3D image formats of the reproducing apparatus and the display apparatus, if the 3D image formats of the reproducing apparatus and display apparatus are erroneously set to different formats, there are cases where it is difficult to read a message of the OSD display, even if the OSD display is provided.

In order to solve to above problem, it is therefore an object to provide a reproducing apparatus which allows users to adequately determine the OSD display information displayed on a display apparatus when 3D image formats are different between the reproducing apparatus and display apparatus.

### SUMMARY

The reproducing apparatus according to the first aspect includes an OSD creating unit operable to create an OSD display image, an OSD combining unit operable to combine an image and the OSD display image created in the OSD creating unit, and an outputting unit operable to output a signal of the image with which the OSD display image is combined by the OSD combining unit, to a display apparatus which can display an image stereoscopically outside the reproducing apparatus, and, when a 3D image output format of the reproducing apparatus is set to a top and bottom format, the OSD combining unit arranges the OSD display image at a position, of an image inputted in the OSD combining unit, which does not cross a center line dividing the image into left and right images.

The reproducing apparatus according to the second aspect includes an OSD creating unit operable to create an OSD display image, an OSD combining unit operable to combine an image and the OSD display image created in the OSD creating unit, and an outputting unit operable to output a signal of the image with which the OSD display image is combined in the OSD combining unit, to a display apparatus which can display the image stereoscopically outside the reproducing apparatus, wherein, when a 3D image output format of the reproducing apparatus is set to a side by side format, the OSD combining unit arranges the OSD display image at a position of an image inputted by the OSD combining unit, which does not cross a center line dividing the image into upper and lower images.

With the reproducing apparatus according to the first aspect, when the 3D image output format of the reproducing apparatus is set to the top and bottom format, an OSD display image is combined at a position which does not cross the center line of the input image dividing the image into left and right images. With this configuration, when, for example, the 3D image format of the display apparatus is set to the side by side format, the display apparatus displays an image in which images of the right half area and left half area of the input image are overlaid. Here, if an OSD image is combined crossing the center line of the input image dividing the image into left and right images, in other words, crossing the right half area and left half area of the input image, when the images of the right half area and left half area of the input image are overlaid, the portion of the right half area and the portion of the left half area in the OSD display image are overlaid, thereby making it difficult to read the OSD display, particularly, texts. However, according to the first aspect, the 3D image output format of the reproducing apparatus is set to the top and bottom format, an OSD display image is arranged at a position which does not cross the center line of the image inputted in an OSD combining unit dividing the image into left and right images. Therefore, even when the right half area and left half area in an OSD display image are overlaid, the OSD display image is not overlaid, so that it is possible to read the OSD display.

With the reproducing apparatus according to the second aspect, when the 3D image output format of the reproducing apparatus is set to the side by side format, an OSD display image is combined at a position which does not cross the center line of the inputted image dividing the image into upper and lower images. With this configuration, when, for example, the 3D image format of the display apparatus is set to the top and bottom format, the display apparatus displays an image in which images of the upper half area and lower half area of the input image are overlaid. Here, if an OSD display image is combined crossing the center line of the input image dividing the image into upper and lower images, in other words, crossing the upper half area and lower half area of the input image, when the images of the upper half area and lower half area of the input image are overlaid, the portion of the upper half area and the portion of the lower half area in the OSD display image are overlaid, thereby making it difficult to read OSD display, particularly, texts. However, according to the first aspect, the 3D image output format of the reproducing apparatus is set to the side by side format, an OSD display image is arranged at a position which does not cross the center line of the images inputted in an OSD combining unit dividing the image into upper and lower images. Therefore, even when the upper half area and lower half area in an OSD display image are overlaid, the OSD display image is not overlaid, so that it is possible to read OSD display.

Thus, according to each aspect, it is possible to provide a reproducing apparatus which allows users to adequately determine information of OSD display displayed on a display apparatus even when 3D image formats are different between the reproducing apparatus and display apparatus.

### BRIEF DESCRIPTION OF DRAWINGS

FIG. 1 is a diagram of a configuration of a system according to Embodiment 1.

FIG. 2 is a diagram of a configuration of a reproducing apparatus according to Embodiment 1.

FIG. 3 is a flowchart of outputting a test image according to Embodiment 1.

FIG. 4 is a view illustrating output screens based on a side by side format according to Embodiment 1.

FIG. 5 is a view illustrating output screens when images are outputted erroneously in a top and bottom format to a display apparatus of a side by side format according to Embodiment 1.

FIG. 6 is a view illustrating output screens on a display apparatus of a top and bottom format according to Embodiment 1.

FIG. 7 is a view illustrating output screens when images are outputted erroneously in a side by side format to a display apparatus of a top and bottom format according to Embodiment 1.

FIG. 8 is a diagram of a configuration of a disc according to other embodiment.

FIG. 9 is a view illustrating an output screen when images are outputted to a display apparatus based on a 2D format according to the other embodiment.

FIG. 10 is a view illustrating an output screen when images are outputted erroneously in a side by side format in prior art.

FIG. 11 is a view illustrating an output screen when images are outputted erroneously in a top and bottom format in prior art.

### DETAILED DESCRIPTION OF PREFERRED EMBODIMENTS

Hereinafter, embodiments will be described referring to the drawings.

### Embodiment 1

### 1. Configuration

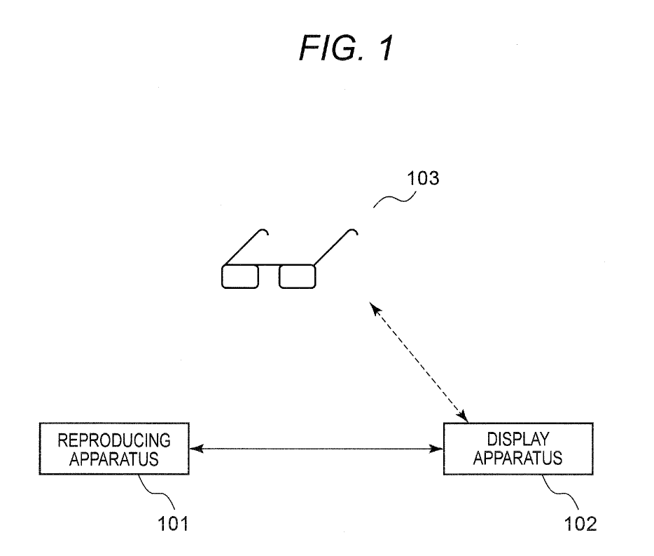

A system using dedicated glasses will be described as an example of a system of a stereoscopic image device according to the present embodiment. FIG. 1 illustrates a configuration of an entire system of the stereoscopic image device according to the present embodiment. The system of the stereoscopic image device includes a reproducing apparatus 101, a display apparatus 102 and 3D glasses 103.

The reproducing apparatus 101 reproduces 3D contents (for example, a content of a Blu-ray disc for 3D images). The reproducing apparatus 101 is connected to the display apparatus 102 through a HDMI cable, and can display an image which is reproduced on the display apparatus 102. The reproducing apparatus 101 supports a plurality of different 3D image output formats. With the present embodiment, it is assumed as an example that the reproducing apparatus 101 supports the top and bottom format and the side by side format.

The display apparatus 102 receives 3D image signals outputted from the reproducing apparatus 101, and displays 3D images. The 3D glasses 103 are dedicated glasses supporting the reproducing apparatus 101, and the user wears the 3D glasses 103 and views 3D contents. The 3D glasses 103 are, for example, liquid crystal shutter type glasses. The display apparatus 102 outputs a left eye image and a right eye image alternately. The 3D glasses 103 open and close the left or right shutter in synchronization with a left image and right image outputted from the display apparatus 102. In addition, the display apparatus 102 and 3D glasses 103 may adopt other systems such as, for example, those shown in Background Art, instead of the liquid crystal shutter system.

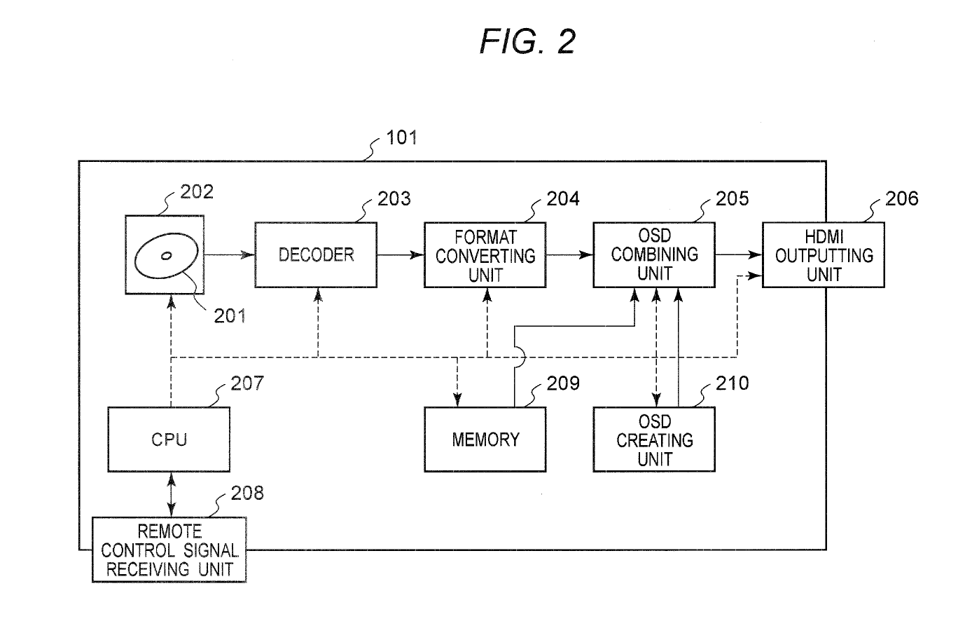

FIG. 2 illustrates a configuration inside the reproducing apparatus 101 according to the present embodiment. The reproducing apparatus 101 has a disc driving unit 202, a decoder 203, a format converting unit 204, an OSD combining unit 205, a HDMI outputting unit 206, a CPU 207, a remote control signal receiving unit 208, a memory 209 and an OSD creating unit 210. When a 3D content is reproduced, the disc driving unit 202 reads a signal of the disc 201 and outputs the signal to the decoder 203. The decoder 203 decodes the signal read from the disc 201. The decoder 203 decompresses the compressed image and audio signals, and outputs the 3D image signal and audio signals. The format converting unit 204 receives the 3D image signal decoded and outputted from the decoder 203. The format converting unit 204 converts the 3D image signal into an image of a format according to the 3D image output format set by the user. Further, the format converting unit 204 outputs the audio signal as it is without converting the audio signal.

The OSD creating unit 210 generates data for a display image for operating a device (OSD display image), based on the command of the CPU 207. The OSD display image includes, for example, text information “Please set the television to 3D”. The OSD display image is an image of, for example, a rectangular shape having the size in which this text information can be arranged. The OSD combining unit 205 combines the 3D image converted in the format converting unit 204 and the OSD display image generated in the OSD creating unit 210, and outputs the combined image to the HDMI outputting unit 206. The OSD combining unit 205 can combine and output image data stored in the memory 209 and the OSD display image generated in the OSD creating unit 210. The OSD combining unit 205 outputs the audio signal as it is without converting the sound signals.

The HDMI outputting unit 206 outputs the image signal and audio signal inputted from the OSD combining unit 205.

The memory 209 stores data of test pattern images. The test pattern image is an image for confirming whether or not images outputted from the reproducing apparatus 101 can be viewed adequately on the display apparatus 102. The 3D image output format of the reproducing apparatus 101 can be set by the user. With the present embodiment, data for the top and bottom format and data for the side by side format are stored as data of test pattern images. When the output format is changed by the user to an output format which is different from the currently set output format, the CPU 207 causes the memory 209 to output the test pattern image matching the newly set output format such that the user can confirm the test pattern image, and causes the OSD combining unit 205 to combine the output test pattern image and OSD display image to output to the HDMI outputting unit 206. While data of a test pattern image is outputted, the OSD combining unit 205 does not combine images outputted from the format converting unit 204. In addition, although the OSD combining unit 205 is configured to combine the OSD display image after the format of the 3D image is converted in the format converting unit 204, the OSD combining unit 205 may be configured to convert the format after combining the OSD display image. That is, after combining the OSD display image in the OSD combining unit 205, the 3D image format may be converted into an output format supported by the format converting unit 204. In this case, only two patterns of a left eye pattern and right eye pattern may be stored in the memory 209.

The remote control signal receiving unit 208 receives remote control signals.

The CPU 207 controls each of the above-described components. The CPU 207 receives the remote control signal received in the remote control signal receiving unit 208. The CPU 207 controls each of the above components according to the remote control signal, that is, according to operation contents by the user to the reproducing apparatus 101. The user can set the 3D image output format, confirm test pattern images, and reproduce 3D contents through remote control operations.

### 2. Operation

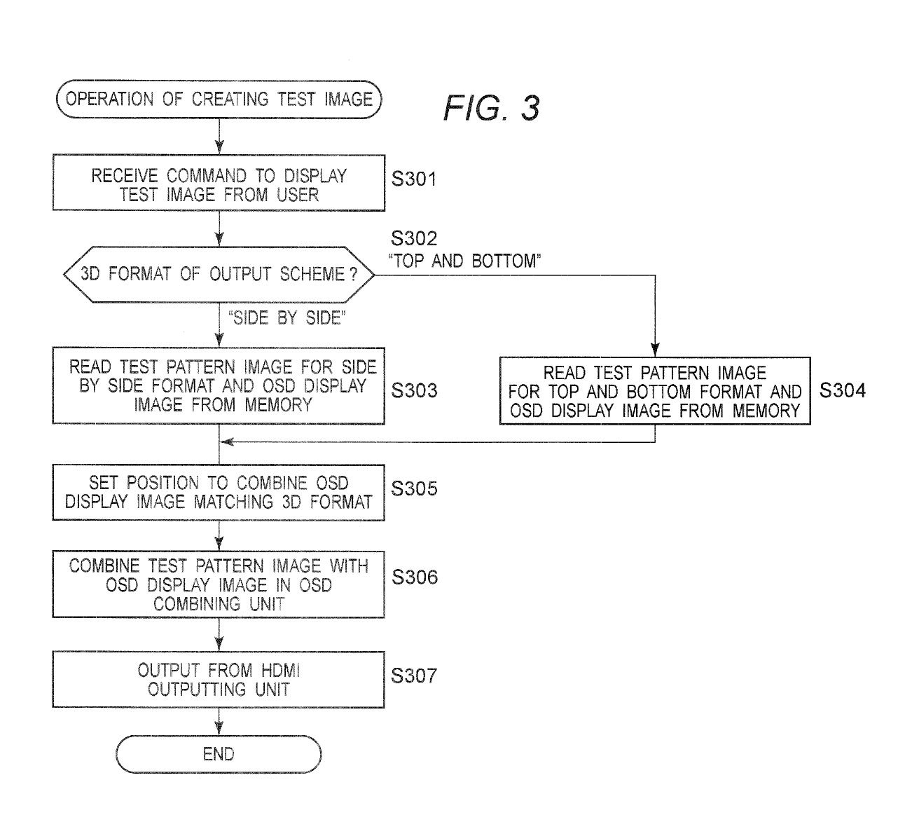

Procedures of outputting a test pattern image from the reproducing apparatus 101 according to the present embodiment configured as described above will be described using FIG. 3. First, the CPU 207 of the reproducing apparatus 101 shows a guide screen for inquiring the user whether to output a test pattern image, and receives an execution command from the user (S301). The CPU 207 determines the 3D image output format which is currently set (S302). The currently set output format is stored in the CPU 207. When the currently set output format is the side by side format, the CPU 207 reads a test pattern image of the side by side format and data of an OSD display image from the memory 209 (S303). When the currently set output format is the top and bottom format, the CPU 207 reads a test pattern image of the top and bottom format and data of an OSD display image from the memory 209 (S304). Next, the position to combine the OSD display image is set according to the set output format (S305).

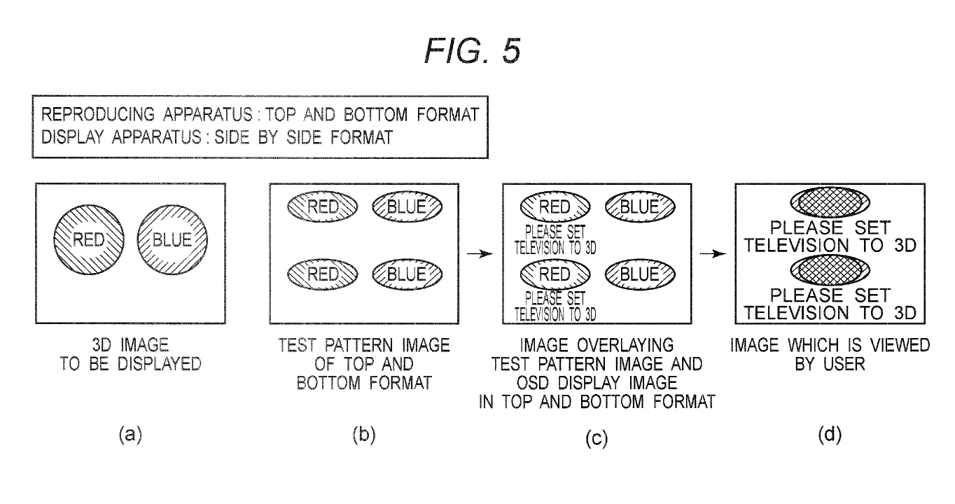

Here, the position to combine the OSD display image according to the top and bottom format will be described. In FIG. 5(c), with OSD display according to the top and bottom format, the OSD display is arranged at a position which does not cross the center line dividing equally the test pattern image into left and right images, more specifically, in a left half (or right half) area of the test pattern image, in the present embodiment (see FIG. 5(c)). By this arrangement, when the OSD image is enlarged twice in the horizontal direction in the display apparatus 102, the OSD display is not cut off at the ends of the screen or is not folded and overlaid.

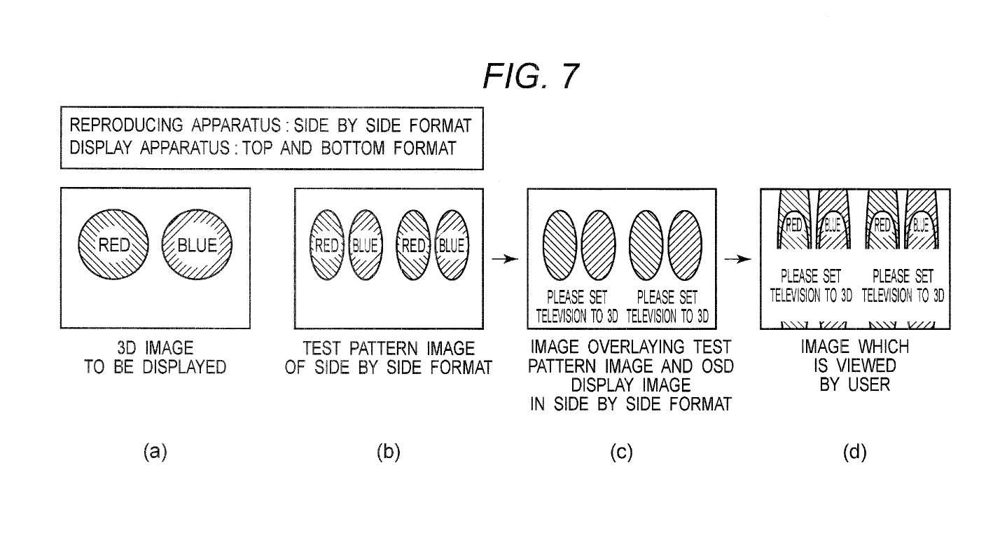

By contrast with this, with OSD display according to the side by side format, the OSD display is arranged at a position which does not cross the center line dividing equally the test pattern image into upper and lower images, more specifically, in a lower half (or upper half) area of the test pattern image, in the present embodiment (see FIG. 7(c)). By this arrangement, when the OSD display image is enlarged twice in the up and down directions in the display apparatus 102, the OSD display is not separated upward and downward.

By setting the position to combine the OSD display image as described above, even when image formats are different between the reproducing apparatus and display apparatus as described later, it is possible to realize OSD display which the user can adequately understand.

After the position to combine the OSD display image is set, the read test pattern image and the OSD display image are combined in the OSD combining unit 205 (S306). The combined image is outputted to the display apparatus 102 through the HDMI outputting unit 206 (S307).

### 2.1 Specific Operation Example

The test pattern image outputted according to the above steps will be described in detail for each format.

2.1.1 Example with the Reproducing Apparatus Set to the Side by Side Format and the Display Apparatus Set to the Side by Side Format

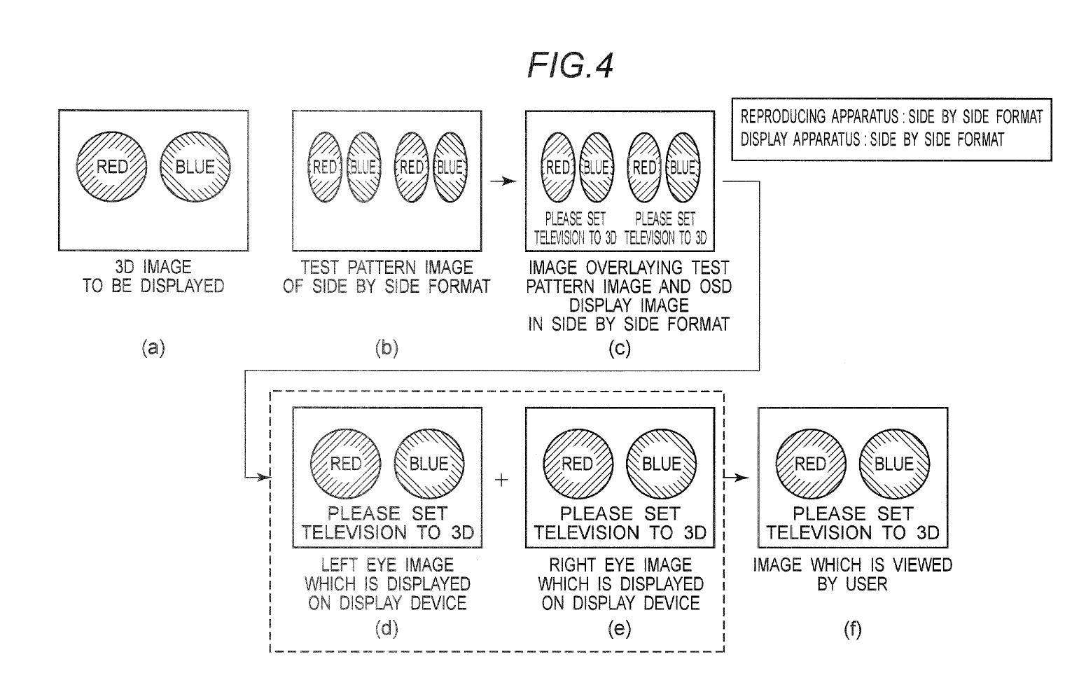

FIG. 4 illustrates how a test pattern image is shown when the output format of the reproducing apparatus 101 is set to the side by side format, and the display format of the display apparatus 102 is set to the side by side format. Thus, the 3D image format of the reproducing apparatus 101 matches 3D image format of the display apparatus 102.

FIG. 4(a) is a view illustrating a 3D image to be displayed based on data of a test pattern image. FIG. 4(b) is a view illustrating a test pattern image of the side by side format. The parallax may be provided between a left eye image and right eye image to allow a user to confirm this test pattern image as the 3D image. For example, the parallax may be provided to cause a red image to project and a blue image to retreat, so that it is possible to inquire the user of which image is shown more nearly and which image is shown farther. If what the images look is different from what the user expects, there is a possibility that the input format of the display apparatus 102 is different from the format of the reproducing apparatus 101, or that display of the left and right sides of the display apparatus 102 is set in a reverse phase due to some causes (for example, open/close timings of glass shutters are reversed on the left and right sides).

FIG. 4(c) is a view illustrating an image combining a test pattern image of the side by side format and an OSD display image of the side by side format. FIG. 4(d) is a view illustrating an image for a left eye which is displayed when the display apparatus is set to the side by side format. FIG. 4(e) is a view illustrating an image for a right eye which is displayed on the display apparatus when the display apparatus is set to the side by side format. FIG. 4(f) is a view illustrating an image (image combining the image illustrated in FIG. 4(d) and the image illustrated in FIG. 4(e) temporally) which is viewed by the user when the display apparatus is set to the side by side format. In FIGS. 4(d) and 4(e), the display apparatus 102 divides the input image (image illustrated in FIG. 4(c)) into the left half and right half, generates a left eye image and right eye image by enlarging the divided images twice in the horizontal direction, and outputs the generated left eye image and right eye image alternately. When no parallax is provided in a test pattern image, the image is viewed by the user as illustrated in FIG. 4(f) regardless of whether or not the user wears the 3D glasses 103. When the parallax is provided in a test pattern image, the portion other than OSD display looks slightly doubly indistinct when the user does not wear the 3D glasses 103.

2.1.2 Example with the Reproducing Apparatus Set to the Top and Bottom Format and the Display Apparatus Set to the Side by Side Format

FIG. 5 is a view illustrating how an image looks when the output format of the reproducing apparatus 101 is set to the top and bottom format due to the user's error of setting although the display format of the display apparatus 102 is set to the side by side format. FIG. 5(a) is a view illustrating a 3D image to be displayed. FIG. 5(b) is a test pattern image of the top and bottom format. FIG. 5(c) is an image combining a test pattern image of the top and bottom format and an OSD display image of the top and bottom format. FIG. 5(d) illustrates a test image which is displayed on the display apparatus 102 when the display apparatus 102 is set to the side by side format.

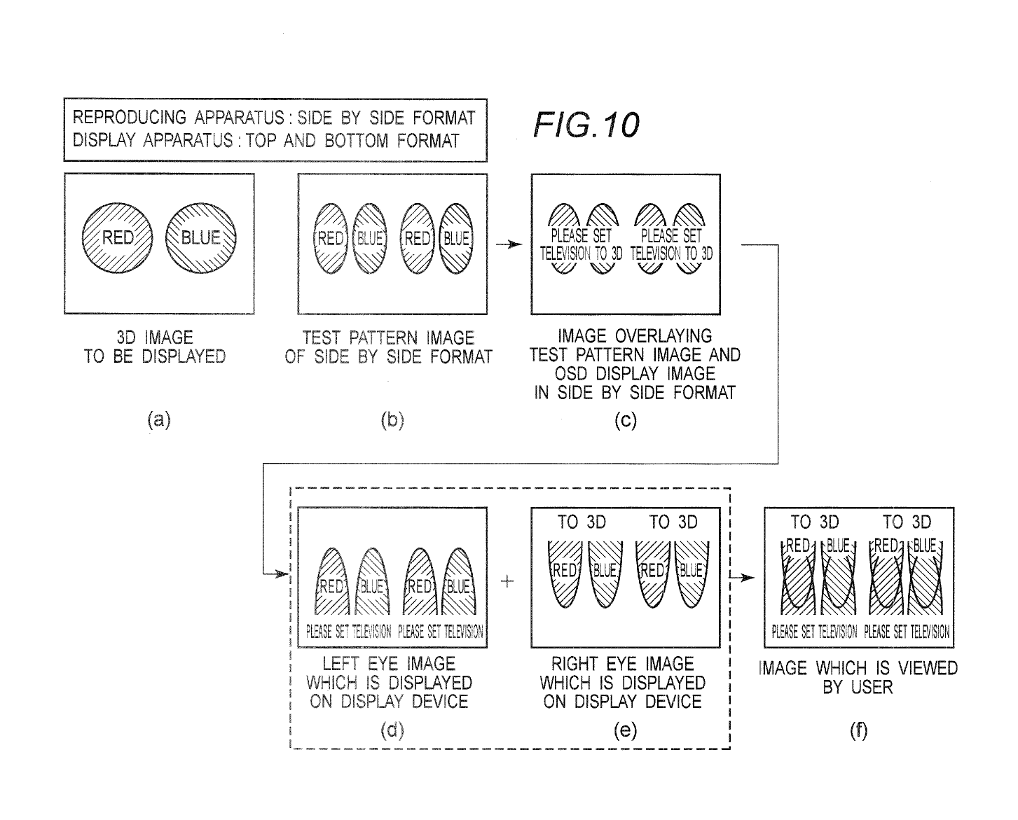

FIG. 10 is a view illustrating the above-described conventional example. FIG. 10 illustrates that the output format of the reproducing apparatus 101 is set to the top and bottom format due to user's error of setting although the display format of the display apparatus 102 is set to the side by side format like FIG. 5. In FIG. 10(d), the OSD display image is enlarged twice in the horizontal direction, and therefore the OSD display image is folded and overlaid, thereby making it difficult to read texts forming OSD display. By contrast with this, in case of FIG. 5(d) of the present embodiment, the texts forming OSD display are not folded, so that it is possible to determine the texts forming OSD display.

In case of FIG. 5(d), the settings of the output formats of the reproducing apparatus 101 and display apparatus 102 do not match, and therefore the test pattern image is not adequately displayed. However, OSD display can be determined, so that the user can adequately set the output formats by displaying the guidance for a method of setting the output formats adequately. By this means, the user can return the setting to the correct setting without getting confused.

2.1.3 Example with the Reproducing Apparatus Set to the Side by Side Format and the Display Apparatus Set to Top and Bottom Format

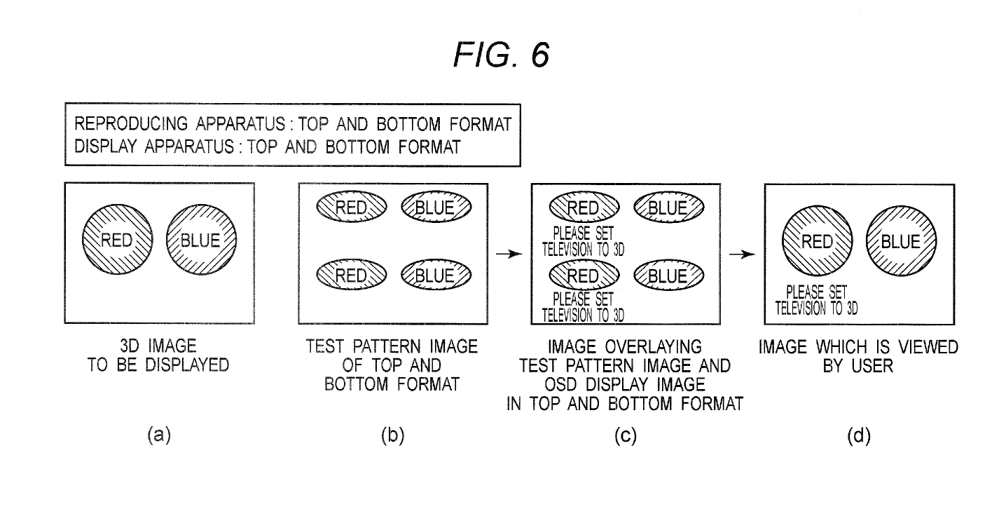

FIG. 6 illustrates how a test pattern image is shown when the output format of the reproducing apparatus 101 is set to the top and bottom format and the display format of the display apparatus 102 is set to the top and bottom format, that is, the output format of the reproducing apparatus 101 and the input format of the display apparatus 102 match.

FIG. 6(a) illustrates a 3D image to be displayed based on data of the test pattern image. FIG. 6(a) is the same as FIG. 4(a). FIG. 6(b) illustrates a test pattern image of the top and bottom format. FIG. 6(c) illustrates an image combining the test pattern image of the top and bottom format and an OSD display image. FIG. 6(d) illustrates a test image which is displayed on the display apparatus 102 when the display apparatus 102 is set to the top and bottom format.

In FIG. 6(d), the display apparatus 102 divides the input image (image illustrated in FIG. 6(c)) into the upper half and lower half, generates a left eye image and right eye image by enlarging the divided images twice in the up and down directions, and outputs the generated left eye image and right eye image alternately. When no parallax is provided in a test pattern image, the image is viewed by the user as illustrated in FIG. 6(d) regardless of whether or not the user wears the 3D glasses 103. When the parallax is provided in a test pattern image, the portion other than OSD display looks slightly doubly indistinct when the user does not wear the 3D glasses 103.

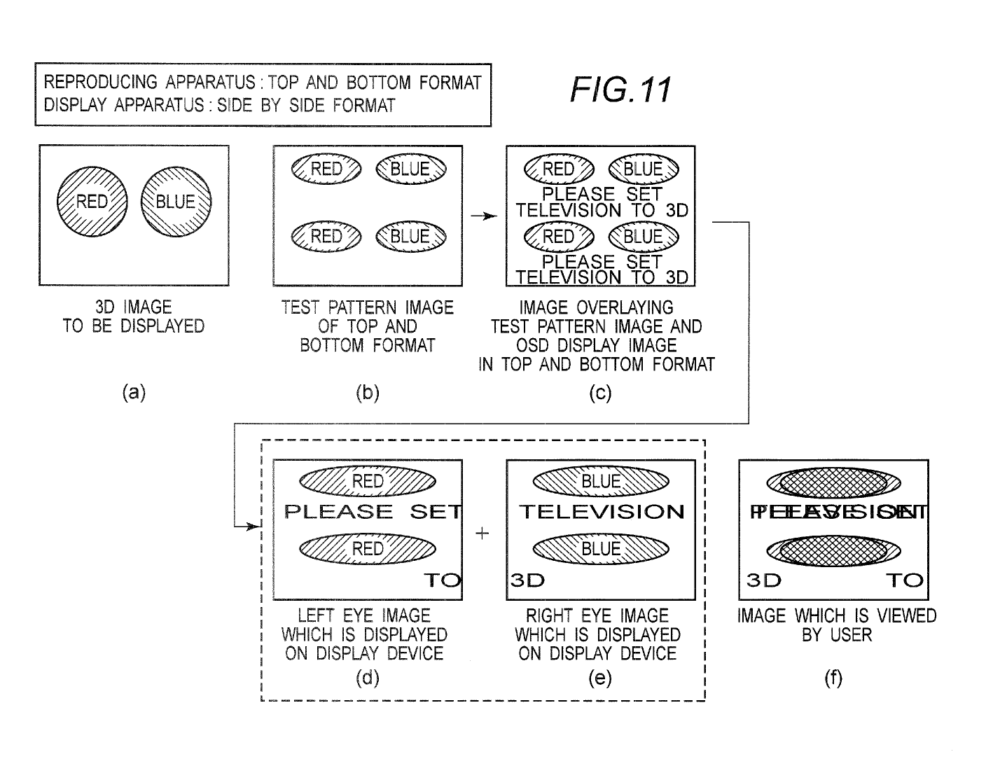

FIG. 11 is a view illustrating the above-described conventional example. FIG. 11 illustrates that the output format of the reproducing apparatus 101 is set to the side by side format due to user's error of setting although the display format of the display apparatus 102 is set to the top and bottom format like FIG. 7. In FIG. 10(d), the OSD display is enlarged twice in the up and down directions, and therefore the OSD display is separated upward and downward, thereby making it difficult to read message. By contrast with this, in case of FIG. 7(d) of the present embodiment, texts forming OSD display are not separated upward and downward, so that it is possible to read a message of OSD display.

In case of FIG. 7(d), the settings of the output formats of the reproducing apparatus 101 and display apparatus 102 do not match, and therefore a test pattern image is not adequately displayed. However, OSD display can be read, so that the user can adequately set the output formats by displaying guidance such as a method of setting the output formats adequately. By this means, the user can return the setting to the correct setting without getting confused.

### 3. Conclusion

As described above, the reproducing apparatus 101 of the present embodiment includes the OSD creating unit 210 which creates an OSD display image, the OSD combining unit 205 which combines an image signal and the OSD display image created by the OSD creating unit 210, and the HDMI outputting unit 206 which can output the image signal with which the OSD display image is combined by the OSD combining unit 205, to the display apparatus 102 which can display images stereoscopically outside the reproducing apparatus 101, and, when the 3D image output format of the reproducing apparatus 101 is set to the top and bottom format, the OSD combining unit 205 arranges the OSD display image at a position which does not cross the center line of the image inputted in the OSD combining unit 205 dividing the image into left and right images.

By this configuration, even when, for example, the output format of the reproducing apparatus 101 is the top and bottom format and the display format of the display apparatus 102 is set to the side by side format, the user can adequately understand the OSD display. Consequently, the user can perform an operation of returning the setting to the correct setting and the like without confusion.

Further, the reproducing apparatus 101 of the present embodiment includes the OSD creating unit 210 which creates an OSD display image, the OSD combining unit 205 which combines an image signal and the OSD display image created by the OSD creating unit 210, and the HDMI outputting unit 206 which can output the image signal with which the OSD display image is combined by the OSD combining unit 205, to the display apparatus 102 which can display images stereoscopically outside the reproducing apparatus 101, and, when the 3D image output format of the reproducing apparatus 101 is set to the side by side format, the OSD combining unit 205 arranges the OSD display image at a position which does not cross the center line of the image inputted in the OSD combining unit 205 dividing the image into upper and lower images.

By this configuration, even when the 3D image output format of the reproducing apparatus 101 is the side by side format and the display format of the display apparatus 102 is set to the top and bottom format, the user can adequately understand the OSD display. Consequently, the user can perform an operation of returning the setting to the correct setting and the like without confusion.

Thus, according to the present embodiment, even when 3D image formats are different between the reproducing apparatus and display apparatus, the user can adequately determine information of OSD display which is displayed on the display apparatus.

### Other Embodiments

Regardless of the 3D image format, OSD display may be displayed only in one area which is partitioned by the center line dividing the screen (test pattern image) into the left half and right half and the center line dividing the screen (test pattern image) into the upper half and lower half (that is, one fourth of the area of the screen). In other words, an OSD display image may be combined in an area of a right half or left half and an upper half or lower half of an image inputted in the OSD combining unit 205.

By this means, either in the case where the 3D image output format of the reproducing apparatus 101 is the top and bottom format and the display format of the display apparatus 102 is set to the side by side format or in the case where the 3D image output format of the reproducing apparatus 101 is the side by side format and the display format of the display apparatus 102 is set to the top and bottom format, the user can adequately understand OSD display. Consequently, the user can perform an operation of returning the setting to a correct setting and the like without confusion.

When OSD display is displayed only in the one fourth of the area, the OSD display is displayed only in one of the left eye image and right eye image. Therefore, when the user views 3D OSD display by wearing the 3D glasses 103, the OSD can be seen with only one eye, and therefore visibility decreases. To solve this problem, when an image is outputted according to the top and bottom format, it is preferable to display, the same OSD display at the same position in each of two areas of the upper half or each of two areas of the lower half of the four divided areas. Further, it is preferable to display the same OSD display at the same position in each of two areas of the left half or each of two areas of the right half of the four divided areas.

That is, when the screen is divided into four, the OSD combining unit 205 may arrange the OSD display at, at least, two positions in two of the four divided areas, more specifically, the first position in the one divided area and the second position in another divided area. When the image outputted from the HDMI outputting unit 206 is displayed stereoscopically on the display screen of the display apparatus 102, positions to display the OSD displays arranged in the first position and the second position need to match.

By this means, the user can view a higher quality OSD display image.

When the screen is divided into four areas, the OSD display image may be arranged in, for example, an upper left area and lower right area or in an upper right area and lower left area. In this case, even if the arrangement position in each area does not match, OSD display images do not overlay each other. Consequently, the user can determine contents of OSD display.

Further, as described in the present embodiment, an image including text information is used as an OSD display image. That is, the OSD display image includes text information. Compared to display using graphics and pictures, the user has difficulty in recognizing texts when they are overlaid. Therefore, the reproducing apparatus 101 of the present embodiment is particularly useful when the OSD display image includes texts. It is needless to say that the technical idea of the present embodiment is applicable when OSD display is configured with a graphic or picture.

Further, the reproducing apparatus 101 of the present embodiment has the memory 209 which stores image data of the side by side format and image data of the top and bottom format, and the test pattern image to be combined with an OSD display image by the OSD combining unit 205 is created from an image of the side by side format or an image of the top and bottom format stored in the memory 209.

Thus, the reproducing apparatus 101 reads images from the memory 209, so that it is not necessary to create additional 3D images.

Further, the reproducing apparatus 101 of the present embodiment further includes the remote control receiving unit 208 which receives a command to display a test image from the user, and, when the remote control signal receiving unit 208 receives a command to display a test image from the user, the HDMI outputting unit 206 outputs the image combined in the OSD combining unit 205 to the display apparatus 102 outside the reproducing apparatus 101.

By this means, before content recorded in the reproducing apparatus 101 is reproduced, the user can recognize whether or not the settings of the reproducing apparatus 101 and display apparatus 102 are correct based on a test image.

With the present embodiment, when the input format of the display apparatus 102 is the top and bottom format or side by side format, even if a 3D image of a format such as a checker board format, line by line format, or the like other than the top and bottom format or side by side format is outputted, cases do not occur where a message such as texts forming OSD display cannot be read.

Although cases have been explained with the present embodiment where OSD display is provided in a test pattern image, it is not limited to this. For example, when images of general contents such as movies are displayed, the above OSD display may be provided.

Further, although cases have been explained with the present embodiment where the outputting unit is the HDMI outputting unit 206, it is not limited to this. That is, the outputting unit only needs to output 3D format image signals.

Further, with the present embodiment, although cases have been explained with the present embodiment where the reproducing apparatus reproduces a disc, it is not limited to this. That is, the reproducing apparatus only needs to output 3D images. For example, the reproducing apparatus may be a apparatus which decodes and outputs 3D image data recorded in another storage medium such as a HDD or flash memory, or may be a apparatus which receives and outputs broadcasting supporting the 3D vision.

Further, with the present embodiment, although an example that the OSD display image is a test pattern image that is stored in the memory 209, it is not necessary to store in the reproducing apparatus 101 side. The OSD display image may be an image that is stored in the recording medium capable of being read by reproducing apparatus 101 such as, for example, disk 201 or the like.

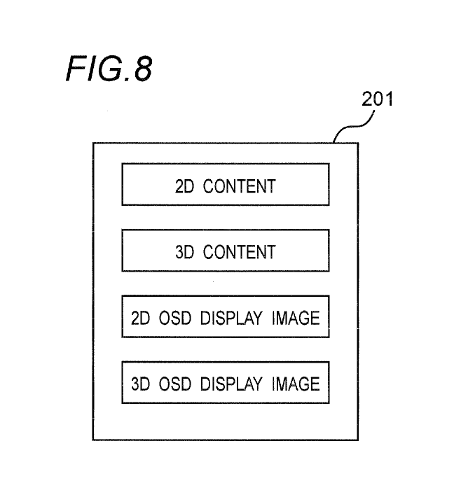

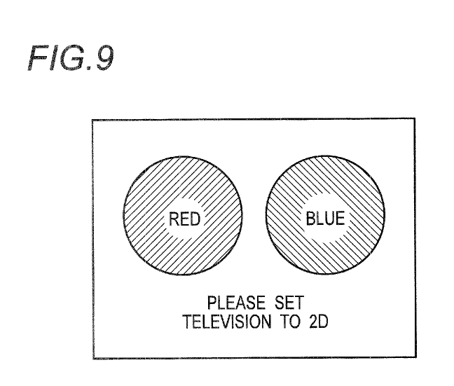

Switching between formats of 3D images has been explained with the above embodiment. However, as the disc 201, there is a disc storing 2D contents and 3D contents. In such a disc, a 2D OSD display image and 3D OSD display image may be stored. FIG. 8 is a configuration diagram of the disc 201 storing both of 2D image contents and 3D contents. The disc 201 stores 2D contents, 3D contents, 2D OSD display images and 3D OSD display images. In this disc 201, the OSD combining unit 205 arranges a 2D OSD display image and 3D OSD display image read from the disc 201, at predetermined positions of an image. The 3D OSD display image is arranged as in the above-described embodiment. By contrast with this, although the 2D OSD display image may be arranged at any position, the 2D OSD display image is arranged at the center as illustrated in, for example, FIG. 9. Thus, the OSD combining unit 205 changes OSD display arrangement positions of 3D contents and 2D contents.

### INDUSTRIAL APPLICABILITY

The present invention can be utilized when a reproducing apparatus supporting the 3D vision and a display apparatus supporting the 3D vision are connected and utilized and when corresponding 3D image output formats are manually set by the user.

What is claimed is:

1. A reproducing apparatus comprising:
an OSD creating unit operable to create an OSD display image;
an OSD combining unit operable to combine an image and the OSD display image created in the OSD creating unit; and
an outputting unit operable to output a signal of the image, with which the OSD display image is combined by the OSD combining unit, to a display apparatus which can display an image stereoscopically outside the reproducing apparatus,
wherein, when a 3D image output format of the reproducing apparatus is set to a top and bottom format, the OSD combining unit arranges the OSD display image at a position in an image inputted in the OSD combining unit, which does not cross a center line dividing the image into left and right images.

2. The reproducing apparatus according to claim 1, wherein the OSD combining unit arranges the OSD display image at the position which does not cross the center line of the image inputted in the OSD combining unit dividing the image into left and right images and which does not cross a center line of the image dividing the image into upper and lower images.

3. The reproducing apparatus according to claim 1, wherein:
the OSD combining unit combines the OSD display image at least at a first position and a second position in the image so that
when the image of the signal outputted from the outputting unit is displayed stereoscopically on a display screen of the display apparatus, the OSD display image combined at the first position and the OSD display image combined at the second position are displayed at a same position.

4. The reproducing apparatus according to claim 1, wherein the OSD display image comprises text information.

5. The reproducing apparatus according to claim 1, further comprising a memory operable to store an image of a side by side format and an image of the top and bottom format,
wherein the image to be combined with the OSD display image by the OSD combining unit is created from the image of the side by side format or the image of the top and bottom format stored in the memory.

6. The reproducing apparatus according to claim 5, further comprising a receiving unit operable to receive a command to display a test image from a user,
wherein, when the receiving unit receives the command to display the test image from the user, the outputting unit outputs the image combined in the OSD combining unit to a display apparatus outside the reproducing apparatus.

7. A reproducing apparatus comprising:
an OSD creating unit operable to create an OSD display image;
an OSD combining unit operable to combine an image and the OSD display image created in the OSD creating unit; and
an outputting unit operable to output a signal of the image, with which the OSD display image is combined by the OSD combining unit, to a display apparatus which can display an image stereoscopically outside the reproducing apparatus,
wherein, when a 3D image output format of the reproducing apparatus is set to a side by side format, the OSD combining unit arranges the OSD display image at a position of an image inputted by the OSD combining unit, which does not cross a center line dividing the image into upper and lower images.

8. The reproducing apparatus according to claim 7, wherein the OSD combining unit arranges the OSD display image at a position which does not cross a center line of the image inputted in the OSD combining unit dividing the image into left and right images and which does not cross the center line of the image dividing the image into upper and lower images.

9. The reproducing apparatus according to claim 7, wherein:
the OSD combining unit combines the OSD display image at least at a first position and a second position in the image; so that
when the image of the signal outputted from the outputting unit is displayed stereoscopically on a display screen of the display apparatus, the OSD display image combined in the first position and the OSD display image combined at the second position are displayed at a same position.

10. The reproducing apparatus according to claim 7, wherein the OSD display image comprises text information.

11. The reproducing apparatus according to claim 7, further comprising a memory operable to store an image of the side by side format and an image of a top and bottom format,
wherein the image to be combined with the OSD display image by the OSD combining unit is created from the image of the side by side format or the image of the top and bottom format stored in the memory.

12. The reproducing apparatus according to claim 11, further comprising a receiving unit operable to receive a command to display a test image from a user,
wherein, when the receiving unit receives the command to display the test image from the user, the outputting unit outputs the image combined in the OSD combining unit to a display apparatus outside the reproducing apparatus.
